(19) United States
(12) Patent Application Publication
(10) Pub. No.: US 2016/0048768 A1
(43) Pub. Date: Feb. 18, 2016

(54) Topic Model For Comments Analysis And Use Thereof

(71) Applicant: HERE Global B.v., Veldhoven (NL)

(72) Inventor: Shizhu Liu, Chicago, IL (US)

(21) Appl. No.: 14/460,588

(22) Filed: Aug. 15, 2014

(51) Int. Cl. G06N 7/00; H04L 29/08; G06F 17/30

(52) U.S. Cl. CPC G06N 7/005; G06F 17/3089; H04L 67/10

(57) ABSTRACT

A method includes determining a plurality of topics corresponding to descriptive text and to comments concerning the descriptive text, wherein each of a number of sets of the plurality of topics comprise a similar topic and one or more supplemental topics. The method includes determining by a computer system probabilities for words, where the probabilities are that the words belong to individual ones of the topics. The method further includes generating, by the computer system and based on comments and the probabilities, a content summary comprising a plurality of comment snippets having positive and negative sentiments toward corresponding ones of the similar or supplemental topics in the sets of topics. Each topic has corresponding comment snippets having positive and negative sentiments. The method includes outputting by the computer system at least a portion of the plurality of topics and corresponding comment snippets. Apparatus and computer program products are also disclosed.

### TECHNICAL FIELD

This invention relates generally to the field of the Internet and in particular to comment analysis for comments posted at websites.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

With the increased popularity of Web 2.0 applications such as social networking websites, video sharing sites, and blogs, comments with dialogue structure have become an important form of communication between users. Specifically, popular entries may contain numerous comments that are much lengthier compared with the descriptive fields provided by the publisher. For instance, in an ecommerce website, a publisher might provide a synopsis or other information about a product. Buyers or users of the product will comment on the product. Such comments have become in many cases extremely important for users. For example, the customers of many ecommerce web sites are accustomed to reading the usage experiences of other customers in comment fields before making a final purchase decision.

Although these comments are beneficial, they can also be problematic. For instance, there could be hundreds or even thousands of comments. It can be a challenge for a consumer to make sense of such numbers of comments, particularly if a particular consumer has a certain requirement that may be addressed by some of these comments but not nearly all of the comments. There may also be common subject matter (e.g., good or bad qualities of a product) spread among the comments, but even for a relatively small number of comments, such common subject matter can be hard to determine. It would be beneficial to improve upon this situation and provide a way to analyze comments to provide a more concise representation of comments.

### BRIEF SUMMARY

This summary is merely exemplary and is not intended to be limiting.

An exemplary method includes determining a plurality of topics corresponding to descriptive text and to comments concerning the descriptive text, wherein each of a number of sets of the plurality of topics comprise a similar topic and one or more supplemental topics. The method includes determining by a computer system probabilities for words, where the probabilities are that the words belong to individual ones of the topics. The method further includes generating, by the computer system and based on comments and the probabilities, a content summary comprising a plurality of comment snippets having positive and negative sentiments toward corresponding ones of the similar or supplemental topics in the sets of topics. Each topic has corresponding comment snippets having positive and negative sentiments. The method further includes outputting by the computer system at least a portion of the plurality of topics and corresponding comment snippets.

Another exemplary embodiment is an apparatus comprising one or more processors and one or more memories including computer program code, where the one or more memories and the computer program code configured, with the one or more processors, to cause the apparatus to perform at least the following: determining a plurality of topics corresponding to descriptive text and to comments concerning the descriptive text, wherein each of a number of sets of the plurality of topics comprise a similar topic and one or more supplemental topics; determining probabilities for words, where the probabilities are that the words belong to individual ones of the topics; generating, based on comments and the probabilities, a content summary comprising a plurality of comment snippets having positive and negative sentiments toward corresponding ones of the similar or supplemental topics in the sets of topics, wherein each topic has corresponding comment snippets having positive and negative sentiments; and outputting at least a portion of the plurality of topics and corresponding comment snippets.

In a further exemplary embodiment, an apparatus comprises: means for determining a plurality of topics corresponding to descriptive text and to comments concerning the descriptive text, wherein each of a number of sets of the plurality of topics comprise a similar topic and one or more supplemental topics; means for determining by a computer system probabilities for words, where the probabilities are that the words belong to individual ones of the topics; means for generating, by the computer system and based on comments and the probabilities, a content summary comprising a plurality of comment snippets having positive and negative sentiments toward corresponding ones of the similar or supplemental topics in the sets of topics, wherein each topic has corresponding comment snippets having positive and negative sentiments; and means for outputting by the computer system at least a portion of the plurality of topics and corresponding comment snippets.

An exemplary computer program product includes a computer-readable storage medium bearing computer program code embodied therein for use with a computer. The computer program code includes: code for determining a plurality of topics corresponding to descriptive text and to comments concerning the descriptive text, wherein each of a number of sets of the plurality of topics comprise a similar topic and one or more supplemental topics; code for determining by a computer system probabilities for words, where the probabilities are that the words belong to individual ones of the topics; code for generating, by the computer system and based on comments and the probabilities, a content summary comprising a plurality of comment snippets having positive and negative sentiments toward corresponding ones of the similar or supplemental topics in the sets of topics, wherein each topic has corresponding comment snippets having positive and negative sentiments; and code for outputting by the computer system at least a portion of the plurality of topics and corresponding comment snippets.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a simplistic block diagram of an exemplary system in which the exemplary embodiments may be practiced;

FIG. 2 is a logic flow diagram for topic modeling for comments analysis and use thereof; and illustrates the operation of an exemplary method, a result of execution of computer program instructions embodied on a computer readable memory, functions performed by logic implemented in hardware, and/or interconnected means for performing functions in accordance with exemplary embodiments;

FIG. 3 illustrates the dependency tree of the sentence “This accessory can abate the damage”, where prior polarity is marked in parentheses for words that exist in SentiWordNet;

FIG. 4 is an webpage containing an example of an entry for a product description at Amazon.com for Sennheiser CX300-B earbuds;

FIG. 5 is an exemplary table of top terms of extracted topics;

FIG. 6 is an exemplary table illustrating summary sentences of corresponding topics;

FIG. 7 is a graph of precision at the top five sentences of positive and negative summary sentences in the corresponding topics; and

FIGS. 8A and 8B, collectively FIG. 8, provide a logic flow diagram for topic modeling for comments analysis and use thereof, and illustrates the operation of an exemplary method, a result of execution of computer program instructions embodied on a computer readable memory, functions performed by logic implemented in hardware, and/or interconnected means for performing functions in accordance with exemplary embodiments.

### DETAILED DESCRIPTION OF THE DRAWINGS

As stated above, it would be beneficial to improve upon the current comment situation for Web 2.0 applications (for instance) and provide a way to analyze comments to provide a more concise representation of comments. To better represent and analyze the content of user-generated data, researchers have tried to extract topics and generate a variety of summaries. Of great interest is the large amount of opinion embedded in the comments and reviews, where it is possible to assume that user generated content is a mixture of opinions and facets. There is research work to exploit a topic model to analyze opinion and fact distribution in weblogs. In the instant disclosure, an aim is to detect supplemental topics in comments with respect to a descriptive text, where the publisher's text is used as the prior knowledge in a topic model.

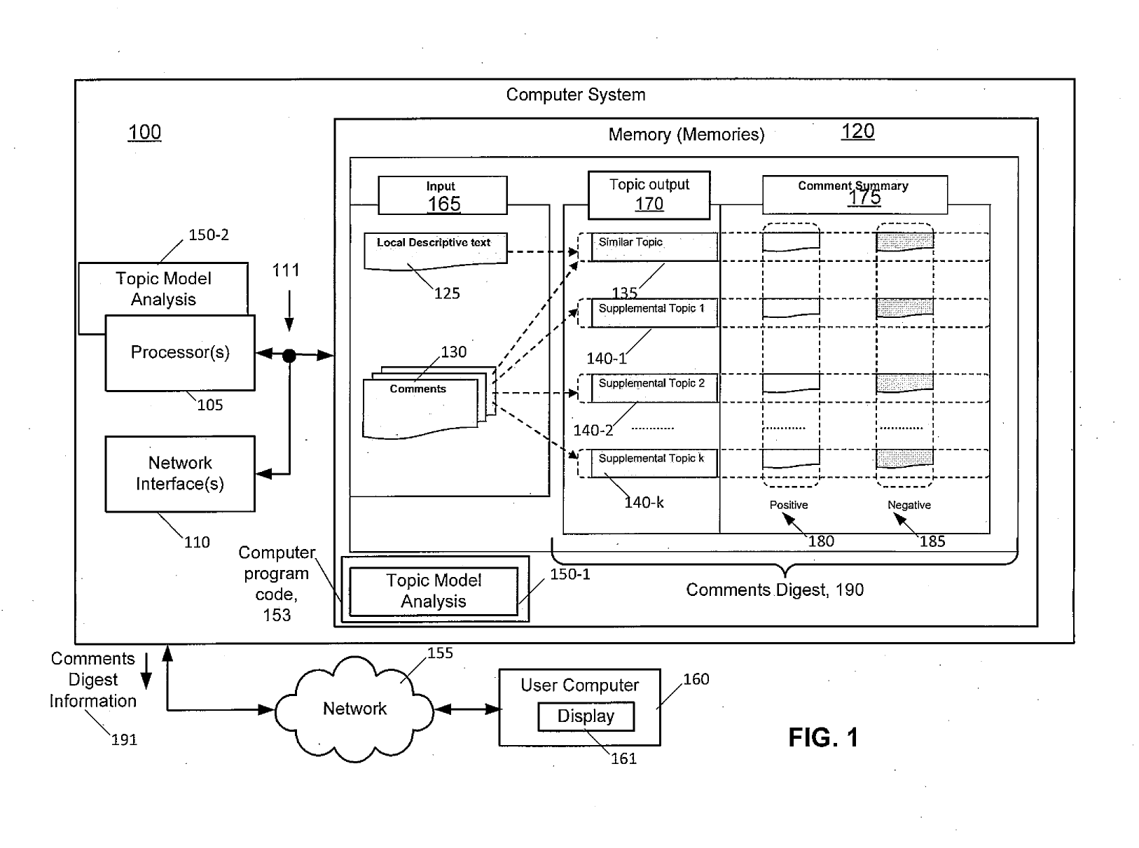

To construct a comment oriented summary, it is proposed to use a semi-supervised generative model to describe the generation of comments and further select summary sentences according to the estimated distribution of the model. This approach stems from two basic observations: First, most comments are written to express writer sentiments. Second, comments are either a response to a publisher written descriptive text or topics which were never mentioned by the publisher. Thus, terms of descriptive fields frequently appear in response comments while supplemental topics are discussed with a different group of terms. It is hypothesized that during the writing process of a comment, a user will likely choose terms mentioned in the descriptive fields provided by the publisher and associate them with a positive or negative sentiment. Specifically, the publisher's descriptive fields are cast as a prior and fit the input text using maximum a posterior estimation. With the estimated probabilistic models, one can then naturally obtain similar topics, and several supplemental topics. The most representative sentences of the corresponding similar and supplemental topics are selected to construct the comment summary. FIG. 1 shows an exemplary system illustrating an outline of a proposed approach.

FIG. 1 is a simplistic block diagram of an exemplary system in which the exemplary embodiments may be practiced. The computer system 100 comprises one or more processors 105, one or more memories 120, and one or more network interfaces 110, interconnected though one or more buses 111. The one or more memories 120 include input 165, a comments digest 190, and computer program code 153 including a topic model analysis module 150-1 in an exemplary embodiment. In another exemplary embodiment, the topic model analysis module 150-2 is implemented as hardware in the computer system 100. For instance, the module 150-2 could be implemented as a part of a digital signal processor (e.g., as a processor 105), or could be distinct from a processor 105 and be implemented on a programmable gate array or integrated circuit. The topic model analysis module 150 thus may be implemented as computer program code 153 in the one or more memories 120 or as hardware in the computer system, or as both computer program code 153 and hardware.

The topic model analysis module 150 operates on the input 165, using techniques described herein, to create the comments digest 190. The input 165 includes local descriptive text 125, which could be a product description, product specifications, a blog entry, an article, or the like. The comments 130 correspond to the local descriptive text 125, such as being on the same webpage as the descriptive text 125 or otherwise being directly associated with the local descriptive text 125 (e.g., such as through a link “See comments”). Thus, the comments 130 are comments based on the local descriptive text 125. The topic model analysis modules 150 operates on the local descriptive text 125 and the comments 130 to produce the topic output 170 and the comment summary 175. The topic output 170 is further subdivided into a similar topic 135 and k supplemental topics 140-1 through 140-k. These topics 135, 140 are described below. The comment summary 175 is further subdivided, as described below, into positive comments 180 (that is, comments expressing a positive sentiment for a corresponding topic) and negative comments 185 (that is, comments expressing a negative sentiment for a corresponding topic).

A user, using the user computer 160, accesses the local descriptive text 125 and the comments 130, e.g., via a web browser and the display 161. The user may also access the comments digest 190, e.g., to get a synopsis of the comments 130. The computer system 100 sends the comments digest information 191 to the user computer 160 so that the user computer 160 can display the information 191 on the display 161. The computer system 100 and the user computer 160 are connected via a network 155, such as the Internet.

For ease of reference, the rest of the present disclosure is divided into sections.

### 1. OVERVIEW

In this document, it is described how to automatically mine and summarize topics and opinions in user comments for descriptive text such as product reviews.

Let E denote a collection of entries E={e₁, e₂, e_{|E|}}. Each entry eᵢ is a tuple (dᵢ, Cᵢ), where Cᵢ is a sequence of comments, {c₁, c₂, . . . , c_{|C|}}, corresponding to eᵢ, and dᵢ is the description provided by the publisher.

For the comments of each entry, there exist at least k+1 topics:

Z={Z_{R},Z_{S1},Z_{S2}, . . . ,Z_{Sk}},

where Z_{R} is a topic 135 resembling a portion of the descriptive field provided by the publisher and Z_{S1}, Z_{S2}, . . . , Z_{Sk} are k supplemental topics 140. Thus, there are a total of k+1 topics in this model.

Based on the representation of comments and topics introduced above, the generation process of the comments is modeled by a graph. Assuming there are k+1 topics shared by all the comments of the given entry (e.g., in the local descriptive text 125), FIG. 1 also illustrates an exemplary generation process of a comment using a semi-supervised generative model, e.g., as implemented by the topic model analysis module 150. This method uses semi-supervised clustering algorithms. So, one sets the number of topics as the given parameters. Here, k+1 topics are set: one resembling topic+k supplementary topics. All these k+1 topics will be detected with the clustering algorithms described below, and the resembling topic will be influenced by the seller's descriptive text.

### 2. ADDITIONAL DETAIL

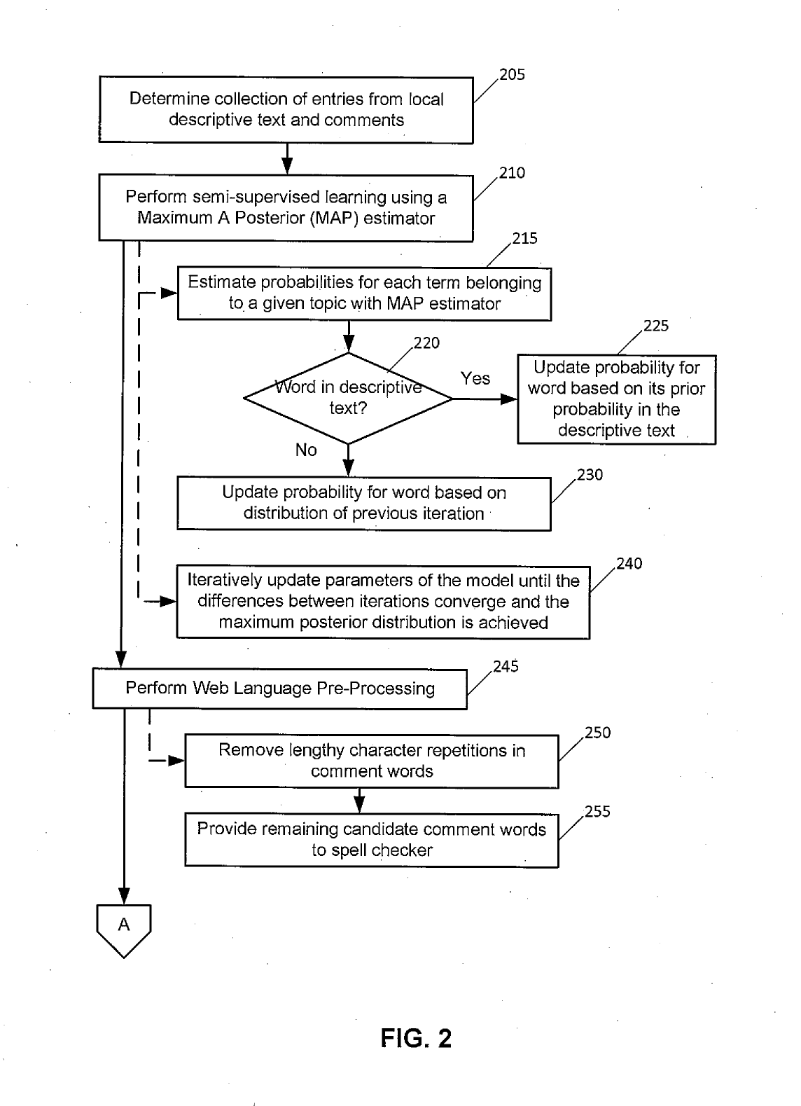

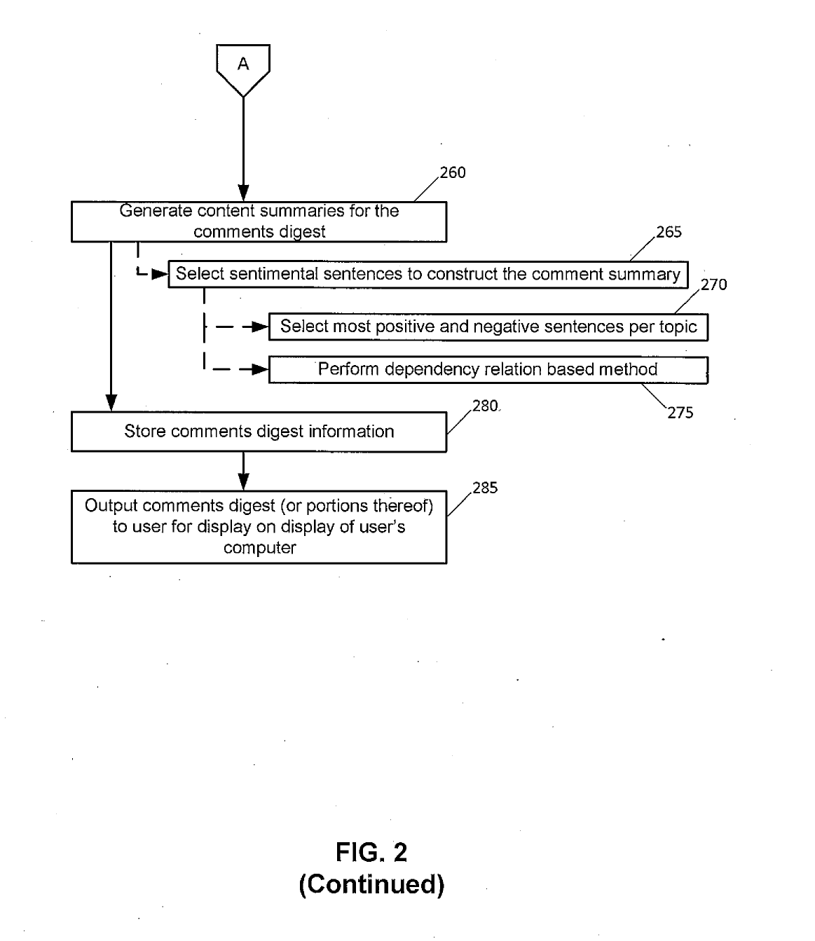

This section is described in part through reference to FIG. 2, which is a logic flow diagram for topic modeling for comments analysis and use thereof. FIG. 2 also illustrates the operation of an exemplary method, a result of execution of computer program instructions embodied on a computer readable memory, functions performed by logic implemented in hardware, and/or interconnected means for performing functions in accordance with exemplary embodiments. Additionally, the blocks in FIG. 2 may be considered to be interconnected means for performing the functions in the blocks. The flow diagram in FIG. 2 is assumed to be performed by the computer system 100 of FIG. 1, e.g., under control at least in part of the topic model analysis module 150.

In block 205, the computer system 100 determines the collection of entries E from the local descriptive text 125 and the comments 130. The rest of the blocks in FIG. 2 are described below.

2.1 Semi-Supervised Learning Using MAP

To find the best set of latent variables that can explain the observed data, a semi-supervised learning process is proposed. See block 210. For instance, the probabilities of each word belonging to given a topic are estimated with a Maximum A Posteriori (MAP) estimator (block 215, which is an example of block 210). During the estimation process, if the words are present in the publisher's descriptive field (e.g., as the local descriptive text 125) (block 220=Yes), the word probability distribution is updated according to its prior probability in the descriptive field (block 225). The remaining words (block 220=No), which are not present in the descriptive field of the local descriptive text 125, have their probability updated according to the word probability distribution of the previous iteration (block 230). This process is repeated until the differences in the posterior of all the comments converge to a given threshold. Each entry e in the collection E can be interpreted as a sample of the following mixture model.

$${p}_{e} ( w ) = {\sum }_{j = 1}^{k + 1} [ {π}_{e , j} p ( w \vert {Z}_{j} ) ] , \qquad ( 1 )$$

where w is a word, π_{e,j} is a mixing weight for the j-th topic, and

$$( {\sum }_{j = 1}^{k + 1} {π}_{e , j} = 1 ) .$$

During the Maximum A Posteriori (MAP) estimation procedure performed by the topic model analysis module 150, the parameters of the model are iteratively updated until the differences between iterations converge and the maximum posterior distribution is achieved (block 240).

In the n-th iteration, the probability distribution of each topic over all the comments is computed as:

$$p ( {z}_{e , w , j} ) = \frac{{π}_{e , j}^{( n )} {p}^{( n )} ( w \vert {Z}_{j} )}{{\sum }_{{j}^{′} = 1}^{k + 1} {π}_{e , {j}^{′}}^{( n )} {p}^{( n )} ( w \vert {Z}_{{j}^{′}} )} , \qquad ( 2 )$$

where z is the topic in the jth iteration.

The prior of all the parameters is given by:

$$p ( Λ ) ∝ {\prod }_{j = 1}^{k + 1} {\prod }_{w ∈ V} {p ( w \vert {Z}_{j} )}^{{σ}_{j} p ( w \vert {r}_{j} )} , \qquad ( 3 )$$

where Λ is the set of all model parameters, V is the vocabulary, and r refers to the resembling topic (i.e., the similar topic 135). Then:

$${Λ}^{′} = {argmax}_{Λ} p ( E \vert Λ ) p ( Λ ) . \qquad ( 4 )$$

It is desired to find supplemental topics not resembling the descriptive information in the local descriptive text 125 provided by the publisher. Hence, set the weight σⱼ=0 for j=1. Consequently, similar topics will be influenced by the distribution of the sentimental corpus and the publisher written descriptive fields in the local descriptive text 125.

Here σⱼ is a confidence parameter for the prior, where Zₚ (P standing for “positive”) and Z_{N} (N standing for “negative”) share an identical confidence parameter.

In the (n+1)-th iteration, each word's distribution over the given topics is recomputed by the following, where c(•) is a coefficient:

$${p ( w \vert {Z}_{j} )}^{( n + 1 )} = \frac{{\sum }_{e ∈ E} c ( w , e ) p ( {Z}_{e , w , j} ) + {σ}_{j} p ( w \vert {r}_{j} )}{{\sum }_{{w}^{′} ∈ V} {\sum }_{{e}^{′} ∈ E} c ( {w}^{′} , {e}^{′} ) p ( {Z}_{{e}^{′} , {w}^{′} , j} ) + {σ}_{j}} . \qquad ( 5 )$$

A prior weight μⱼ is defined as follows:

$${μ}_{j} = \frac{{σ}_{j}}{{\sum }_{{w}^{′} ∈ V} {\sum }_{{e}^{′} ∈ E} c ( {w}^{′} , {e}^{′} ) p ( {Z}_{{e}^{′} , {w}^{′} , j} ) + {σ}_{j}} . \qquad ( 6 )$$

Decaying allows the model to gradually pick up words from the comments. The confidence parameter update is given by the following, where a decay parameter η is used as follows:

$${σ}_{j}^{( n + 1 )} = \{ \begin{matrix}{ησ}_{j}^{( n )} & if {μ}_{j} > δ \\ {σ}_{j}^{( n )} & if {μ}_{j} \leq δ\end{matrix} , \qquad ( 7 )$$

where δ is a threshold.

2.2 Web Language Pre-Processing

Web-language pre-processing is performed in block 245. In comment fields in the comments 130, users are accustomed to discuss and exchange opinions and ideas in an informal, conversation-like manner A limitation of such text communication is the lack of accent that exists in oral language. Thus, users commonly try to ameliorate such inconvenience by repeatedly spelling the vowel or suffix of words. For example, “It is sooooooooo sweeeeeeeeeeeeeet!!!”, “hahahaha, he is so coooooool”, “lololololololol, niceeee! xdxdxd”. Notice that such repetition spelling method is usually applied with exclamation terms. This informal communication may hinder the performance of some comment analyzers. This is because identical words with different number of repetitions of characters will be treated as the distinct words. Existing stemmers and spelling checkers normally fail to consider such features of web language. Here, a web language preprocessing strategy is proposed by removing the repetitions and making use of a spell checker.

Web language pre-processing is performed as follows in an exemplary embodiment. First, remove lengthy character repetitions in comment words (block 250). If the repetition appears at the end of the term and the character is a vowel, remove all the repetitions, and leave one and two repetitions as possible candidates. If the repetition appears at the middle of the term and the repetition is a single character repetition, leave one and two repetitions as possible candidates. Finally, if the length of repetition pair is larger than two characters, remove all the repetitions. Second, all the candidates are provided to spell checker software (block 255), which computes the edit distances between the candidate and dictionary words to produce a suggestion list sorted by distances. That is, for the input term “lolololololol”, output “lol”; for the input term “shooppiiiiiiing”, construct a candidate list: “shooppiing”, “shopiing”, “shoopiing”, “shooping”, “shoopping”, “shoppiing”, “shopping”, “shoping” and provide these to the spell checker software to correct them.

2.3 Content Summaries Generation

In block 260, the computer system 100 generates content summaries for the comments digest. After processing the data, a goal is to produce a set of topics extracted from the comments. Then, one can assign each sentence sᵢ into one of the topics by choosing the topic with the largest probability for generating sᵢ:

$${argmax}_{j} p ( {s}_{i} \vert {Z}_{j} ) = {argmax}_{j} {\sum }_{w ∈ V} c ( w , {s}_{i} ) p ( w \vert {Z}_{j} ) . \qquad ( 8 )$$

To facilitate user opinion understanding in comments, sentimental sentences are selected to construct an opinion summary of the extracted topics (block 265). Naïve baseline strategy (block 270) is discussed and a dependency structure based method (block 275) is also discussed in Section 2.3.1 and Section 2.3.2, respectively, that are used to categorize the sentimental polarity of the relevant sentences. In an exemplary embodiment, the system is based on SentiWordNet, as a lexical resource for opinion mining. SentiWordNet is a lexical resource for opinion mining SentiWordNet assigns to each synset (a set of synonyms) of WordNet three sentiment scores: positivity, negativity, objectivity. SentiWordNet is described in detail in the following papers: A. Esuli, F. Sebastiani, “SentiWordNet: A Publicly Available Lexical Resource for Opinion Mining”, Int'l Conf. on Language Resources and Evaluation (2006); and Stefano Baccianella, Andrea Esuli and Fabrizio Sebastiani, “SentiWordNet 3.0: An Enhanced Lexical Resource for Sentiment Analysis and Opinion Mining In SentiWordNet”, Conf on Language Resources and Evaluation (2006). In the instant usage, each synset of WordNet is assigned three sentiment scores: positivity, negativity, objectivity, which are cast as the global sentimental prior in the exemplary sentiment analysis.

2.3.1 Baseline Strategy

A naive assumption of a sentence's polarity is that positive sentences contain more positive words and negative sentences are composed of more negative words. In this manner, selection is made (block 270) of the most positive and negative sentence of the given topic Zj:

$$\begin{matrix}{argmax}_{j} p ( {s}_{i} \vert {Z}_{{P}_{j}} ) = {argmax}_{j} {\sum }_{w ∈ V} c ( w , {s}_{i} ) p ( w \vert {Z}_{P} ) \cdot {\sum }_{w ∈ V} c ( w , {s}_{i} ) p ( w \vert {Z}_{j} ) , & ( 9 ) \\ {argmax}_{j} p ( {s}_{i} \vert {Z}_{{N}_{j}} ) = {argmax}_{j} {\sum }_{w ∈ V} c ( w , {s}_{i} ) p ( w \vert {Z}_{N} ) \cdot {\sum }_{w ∈ V} c ( w , {s}_{i} ) p ( w \vert {Z}_{j} ) , & ( 10 )\end{matrix}$$

where Z_{P}_{ⱼ} and Z_{N}_{ⱼ} represent the positive and negative aspects of topic Zⱼ. Thus, each topic Zⱼ is aligned with three aspects of sentences: positive (equation (9)), negative (equation (10)), and objective (equation (8)), the top sentences, e.g., in terms of their probability scores as per equations (9) or (10), of positive and negative aspects can be chosen as the sentimental summary of the topic.

2.3.2 Dependency Relation Based Method

A dependency relation based method (performed in block 275 by the computer system 100) is now described. One of the potential problems of the simple bag-of-words approach is the failure to consider the interaction of words within a sentence. To facilitate the discussion, consider the following examples:

1. [[No one]⁻ did [not]⁻[like]⁺ this coffee machine.]⁺

2. [It is [terribly]⁻[fast]⁺ and [convenient]⁺]⁺

3. [There is [little]⁻[truth]⁺ in this book]⁻

4. [The diaper champ [could]⁻[not]⁻ be [easier]⁺ to use.]⁺

5. [This has also become an [important]⁺ and [popular]⁺ feature that the iPod unfortunately does [not]⁻ have.]⁻

In the first example, verb “like” carries a positive sentiment (as indicated by the superscript “+”), but the negated subject “No one” and negator “not” (as indicated by the superscript “−”) shift the overall polarity of the whole sentence back and forth. In the second example, the negative adverb “terribly” does not switch the polarity of the positive abject “fast” and “convenient” but rather intensifies the strength of them. In the third example, “little” plays the role of general polarity shifter. In the fourth example, the auxiliary modal verb “could” flips back the overall polarity after negator “not”. In the fifth example, the overall sentiment polarity is switched by the negator in the complement clause. In these examples, the sentiment polarity of the sentence cannot be judged by counting the number of positive and negative words in a sentence.

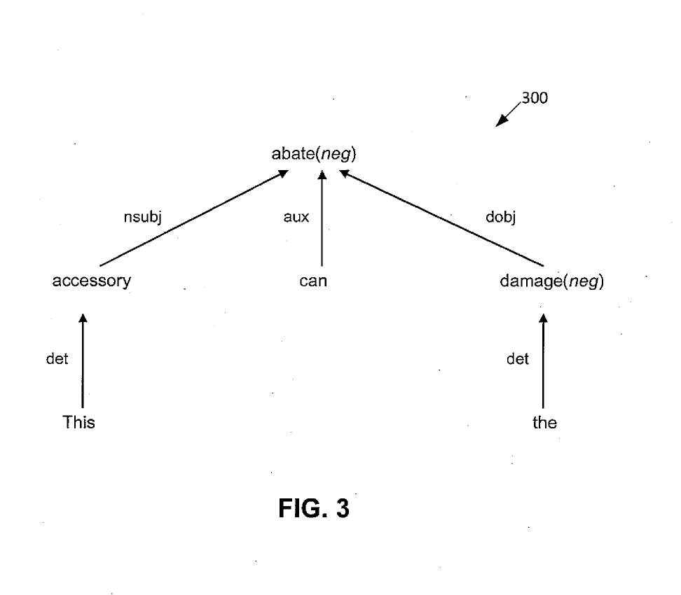

To consider the interactions within sentences, use is made of the dependency tree structure parser. In dependency representation, every node in the tree structure is a surface word (i.e., there are no abstract nodes such as Noun Phrase or Verb Phrase). The edge between a parent and a child specifies the grammatical relationship between the two words. The dependency representation was designed to provide a simple description of the grammatical relationships in a sentence that can easily be understood and effectively used by users without linguistic expertise who want to extract textual relations. Specifically, the relations between words that are not adjacent are represented by the edges directly. FIG. 3 demonstrates a dependency tree structure 300 for the sentence: “This accessory can abate the damage.” There are a number of grammatical relationships, include “nsubj” (nominal subject) between “accessory” and “abate”, “det” (determiner) between “This” and “accessory” and between “the” and “damage”, “aux” (auxiliary) between “can” and “abate”, and “dobj” (direct object) between “abate” and “damage”.

In an exemplary implementation herein, the Stanford statistical parser is used to extract the dependency tree structure of the input sentence. A natural language parser is a program that works out the grammatical structure of sentences, for instance, which groups of words go together (as “phrases”) and which words are the subject or object of a verb. Probabilistic parsers use knowledge of language gained from hand-parsed sentences to try to produce the most likely analysis of new sentences. Technical ideas behind the Stanford statistical parser are found in the following: Marie-Catherine de Marneffe, Bill MacCartney and Christopher D. Manning, “Generating Typed Dependency Parses from Phrase Structure Parses”, un LREC 2006; and Richard Socher, John Bauer, Christopher D. Manning and Andrew Y. Ng, “Parsing With Compositional Vector Grammars”, proceedings of ACL 2013.

In the sentence in FIG. 3, the direct object (dobj) relation between “abate” and “damage” determines the overall polarity. By analyzing the dependency relations in a given sentence, a dependency tree structure based method is proposed to judge the sentiment polarity. For a given sentence, the dependency tree structure 300 is extracted first. Then, each word polarity is marked according to its prior sentiment distribution in the SentiWordNet. For this step, words are labeled in four ways: positive, negative, both, and neutral. After that, specific dependency relations between the word instance and other polarity words to which the word instance may be related are checked along the tree structure from bottom up. If a word and its parents in the dependency tree share an obj (object), adj (adjective), mod or vmod (reduced non-finite verbal modifier) relationship, the modified polarity feature is set to the prior polarity of the word's parent. Note that at least some of these dependencies are described, e.g., in Marie-Catherine de Marneffe and Christopher D. Manning, “Stanford typed dependencies manual” (2008; revised 2013). If the parent is not in SentiWordNet, its (the word's) prior polarity is set to neutral. Finally, some sentence level polarity influencers are searched. For instance, general polarity shifters reverse polarity (e.g., “little truth”, “few mistakes”). Negative polarity shifters typically make the polarity of an expression negative (e.g. “lack of maintenance”).

TABLE 1
below shows features for sentiment classification:

| | Feature Patterns |
|---|---|
| Word Polarity Features | word part-of-speech |
| | prior polarity: positive, negative, both, neutral |
| Modification Features | depended by adjective |
| | depended by negator |
| | depended by adverb (other than not) |
| | depended by intensifier |
| Sentence Features | modal in sentence |
| | clausal complements |
| | negated subject in sentence: e.g. no one, nobody |
| | general polarity shifter: e.g. little, seldom |

2.4 Additional Steps

Returning to FIG. 2, in block 280, the computer system 100 stores comments digest 190 information, e.g., in the one or more memories 120. In block 285, the computer system 100 outputs the comments digest (or portions thereof) to a user for display on display of user's computer. That is, the computer system 100 sends the comments digest information 191, suitable to be displayed on the display 161 of the user computer 160, to the user computer 160. For instance, the comments digest information 191 could be HTML (hypertext markup language) information that can be displayed as table 500, table 600, or both. Block 285 may be performed in response to a request for such information from a user, as explained below.

2.5 Experimental Results

2.5.1 Product Review Dataset

Experiments were carried out on ten different products reviews crawled from Amazon.com, which is an online retailer. Table 2 below shows basic characteristic information of the dataset. In this dataset, the number of words and the number of distinct words in the comment fields are both much larger than their numbers in the publisher descriptive field. Thus, this table indicates the great potential of comments to cover more supplemental topics.

TABLE 2
(where “Avg” is “Average” and “#” is “number”), which illustrates
the basic statistics of a dataset, is as follows:

| | # of words | # of distinct words | Avg(# of distinct words) |
|---|---|---|---|
| Descriptive | 17593 | 9562 | 351.86 |
| field | | | |
| Comments | 250302 | 74209 | 5006.04 |

2.5.2 Sentiment Classifier Performance

To compare the proposed naïve heuristic method with the proposed dependency tree structure based method, a labeled sentiment collection was constructed for testing. In all, 110 sentences from the comment collection were manually annotated with subjectivity information. These sentences were labeled based on sentiment bearing (i.e., polarity is ‘positive’, ‘negative’, or ‘both’), expression, and subjectivity strength. The performance is reported in Table 3. The results show that heuristics that take into account the polarity shift caused by the compositional structure of the expression can perform better than naïve method that fails to consider such a structure.

TABLE 3
sentiment classification accuracy in a review dataset is as follows:

| | Accuracy |
|---|---|
| Baseline Method | 0.6364 |
| Dependency Relation | 0.7182 |
| Method | |

2.4.3 Sample Results

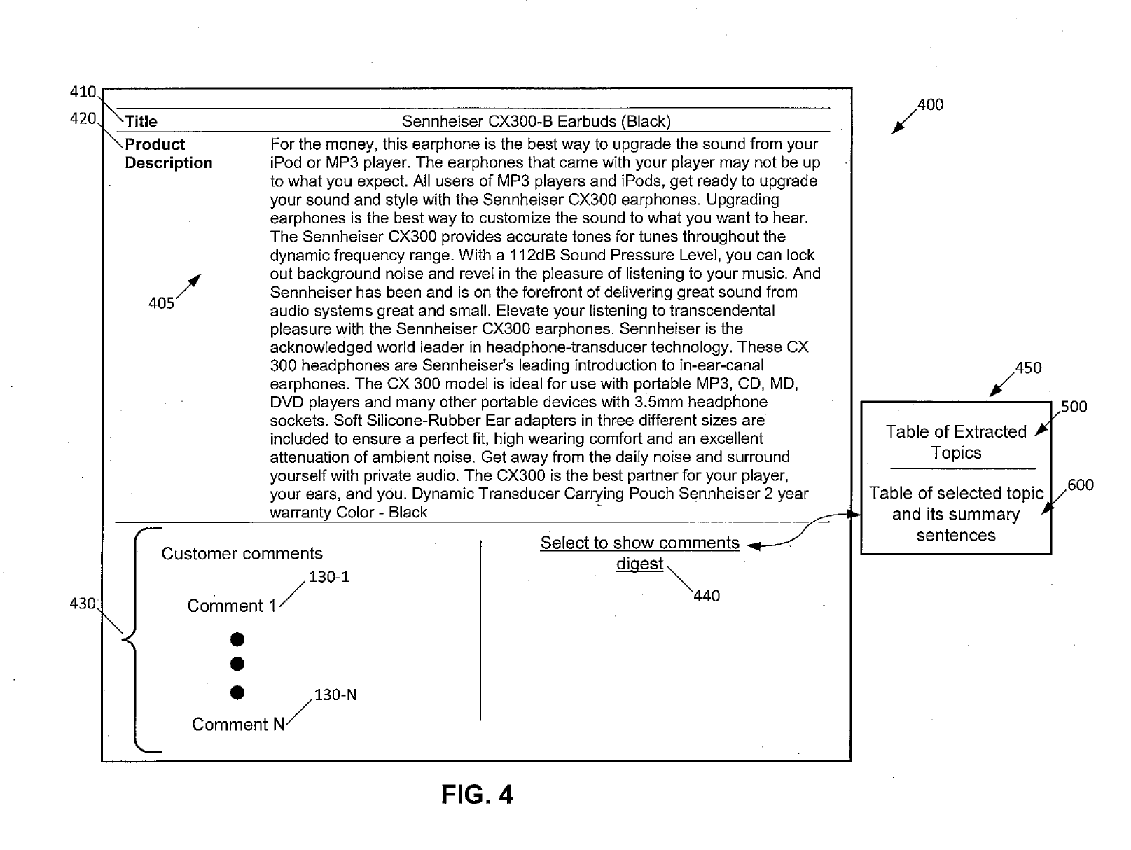

In this section, a few sample results are presented that were obtained by the proposed approach when applied to the reviews of a product on Amazon's website: Sennheiser CX300-B Earbuds. Additionally, one possible way of implementing a system to allow a user to view the comments digest 190 is illustrated by FIGS. 4-6. FIG. 4 is an example of webpage 400 containing an entry 405 for a product description, in this example at Amazon.com for Sennheiser CX300-B earbuds. FIG. 4 presents the title 410 of “Sennheiser CX300-B Earbuds (Black)” and also presents the descriptive text (in the product description 420) written by the seller. The product description is one example of the local descriptive text 125 from FIG. 1. Area 430 of the webpage 400 is used to display customer comments, of which comments 1 130-1 through N 130-N are illustrated as being shown. Note that the number of comments 130 would be in the hundreds or thousands, so only a few of the comments might be accessed by a single webpage 400. The “Select to show comments digest” is (in this example) a link 440 a user can activate (e.g., by clicking with a mouse, touching with a finger on a touchscreen, and the like). If the link 440 is activated by a user, in this example, a popup window 450 is presented, which has a table 500 of extracted topics and also an area for a table 600 of a selected topic and the summary sentences for the selected topic. The popup window 450 is one example of how a user might access the comments digest 190, and many other examples are possible. For instance, the comments digest 190 or some portion thereof could be part of the webpage 400.

In the product description 420, the seller tries to recommend the earbuds (i.e., in-ear headphones) in the product description field. In the seller's text, the product is introduced as a good accessory for portable music and video players. The reputation of the manufacturer, Sennheiser (a German company, which manufactures a wide range of headphones, microphones, and wireless systems), is also emphasized.

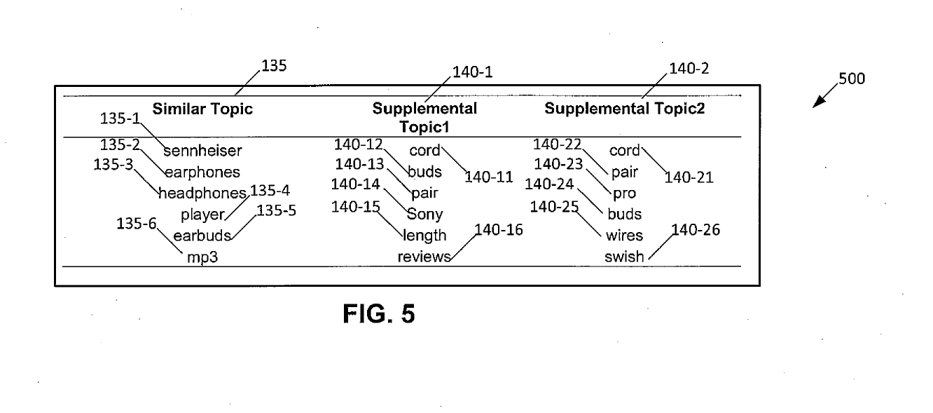

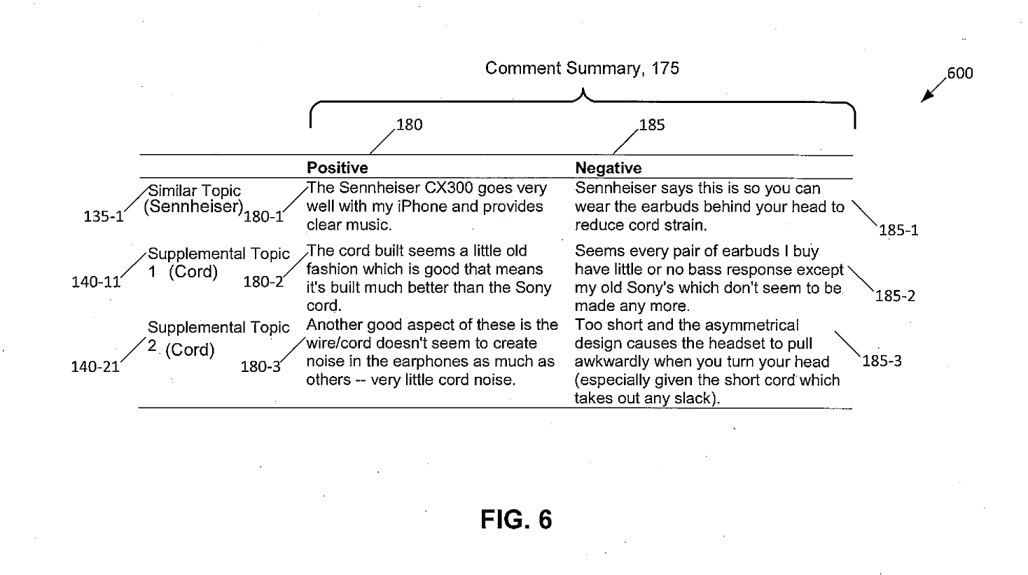

FIG. 5 is a table 500 of top terms of extracted topics. In FIG. 5, the top terms of the extracted sentimental, similar, and supplemental topics by the proposed semi-supervised model (performed by the topic model analysis module 150) are listed. There are six similar topics 135: Sennheiser 135-1; earphones 135-2; headphones 135-3; player 135-4; earbuds 135-5; and mp3 135-6. Each of these corresponds (per row) to a first supplemental topic 140-1, of which there are six: cord 140-11; buds 140-12; pair 140-13; Sony 140-14; length 140-15; and reviews 140-16. Each of the similar topics also corresponds (per row) to a second supplemental topic 140-2, of which there are six: cord 140-21; pair 140-22; pro 140-23; buds 140-24; wires 140-25; and swish 140-26. Some positive and negative adjective and adverb terms appear in the positive and negative topics. In the similar topic 135, frequent terms in the seller's text (from the product description 420) get high ranks. In the top terms of the other two supplemental topics 140-1 and 140-2, there are some terms which do not appear in the description field (i.e., product description 420), such as the name of another earphone manufacturer (Sony), and components of the earbuds (cord, wires, etc.). These are interpreted by the corresponding summary sentences listed in FIG. 6. FIG. 6, in the comment summary 175, illustrates positive comments 180 (180-1 through 180-3), which are comments expressing a positive sentiment, and negative comments 185, which are comments expressing a negative sentiment, as sentences for each of the similar topic 135-1 (i.e., “Sennheiser”), supplemental topic 1 140-11 (i.e., “cord”), and supplemental topic 2 140-21 (i.e., “cord”). This is presented in a table 600 format, although other representations are possible. Note that the table 600 might be shown (e.g., in popup window 450), for instance, if a user selects one of the words in a row in table 500 for a similar topic 135, the supplemental topic 1 140-1, or the supplemental topic 2 140-2.

Sentences of supplemental topic 1 140-1 compare the Sennheiser's product with that of Sony's: some users prefer this Sennheiser earbud's cord's fashion style (see positive comment 180-2), while others point out that its bass response is weaker than the Sony's (see negative comment 185-2). In the sentences of supplemental topic 2, the cord of these earbuds is discussed: the cord reduces noise (see positive comment 180-2), while other users feel uncomfortable with a short cord length (see negative comment 185-2). All such selected opinions could become extremely valuable for customers.

2.4.4 Quantitative Evaluation

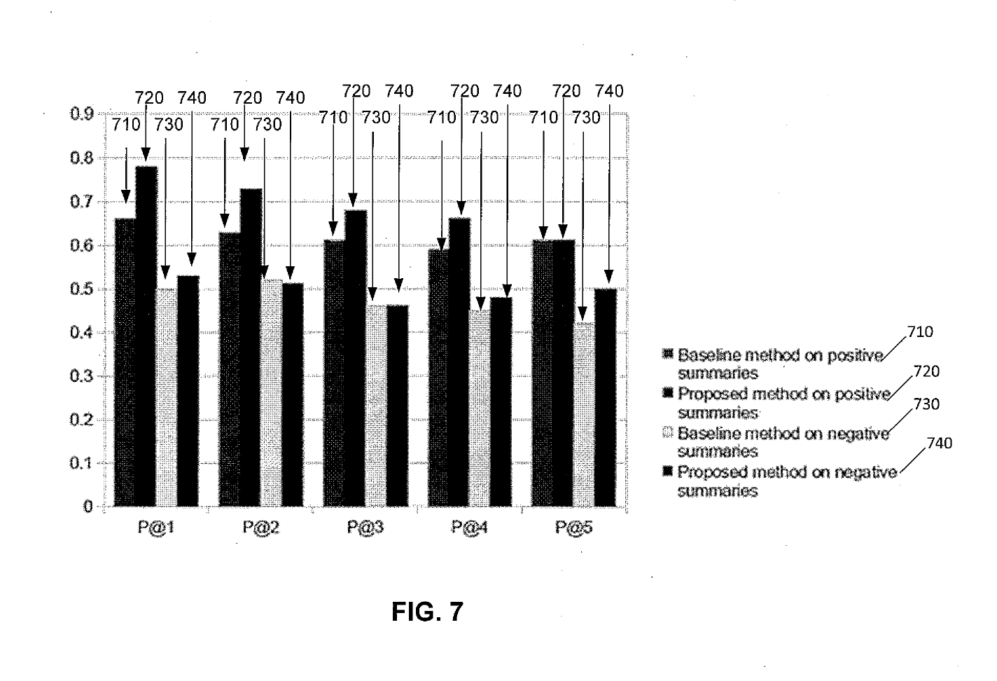

Another advantage of the exemplary proposed comment analysis approach is that this approach makes the evaluation of the proposed generative topic model feasible. The extracted similar and supplemental topics can be evaluated by judging the relevance and the sentiment polarity of the top sentences. (i.e., one can assess if all the top N sentences are related to the summarized topic and if all their polarities are classified correctly). This gives each sentence a binary score: 1 (one) if the sentence should be in the topic and the polarity is right or 0 (zero) otherwise. Accordingly, the precision for the top N sentences is computed for the extracted topics. The sentences are chosen to be evaluated in this way because it is very easy to judge if a sentence is relevant to the given topic but it is difficult to rank the relative relevance of the sentences. For each extracted descriptive topic (similar or supplemental), the relevance and sentimental polarity of the top 1-5 positive and negative sentences are manually judged. The average precision over ten products reviews is demonstrated in FIG. 7, which is a graph of precision at the top five sentences of positive and negative summary sentences in the corresponding topics. That is, “P@1” is the precision of the highest rated positive or negative sentence, and “P@5” is the precision of the fifth-highest rated positive or negative sentence. As shown in the figure, the precision of the dependency structure based approach is better than the baseline approach. This result is compatible with the result in Section 2.2. FIG. 7 also indicates that either with the baseline or dependency tree based method, the precision of positive summaries is better than that of negative ones. This is mainly caused by the fact that in some products reviews, the number of positive comments is much larger than negative ones. In such circumstance, negative sentence detection becomes more difficult. It is also observed that some phrase level slang is hard to parse by a dependency structure parser. Finally, unlike a formal written narrative document, a great number of grammar mistakes exist in comments, which frequently results in incorrect dependency structure output of the parser.

### 3. ADDITIONAL EXAMPLES

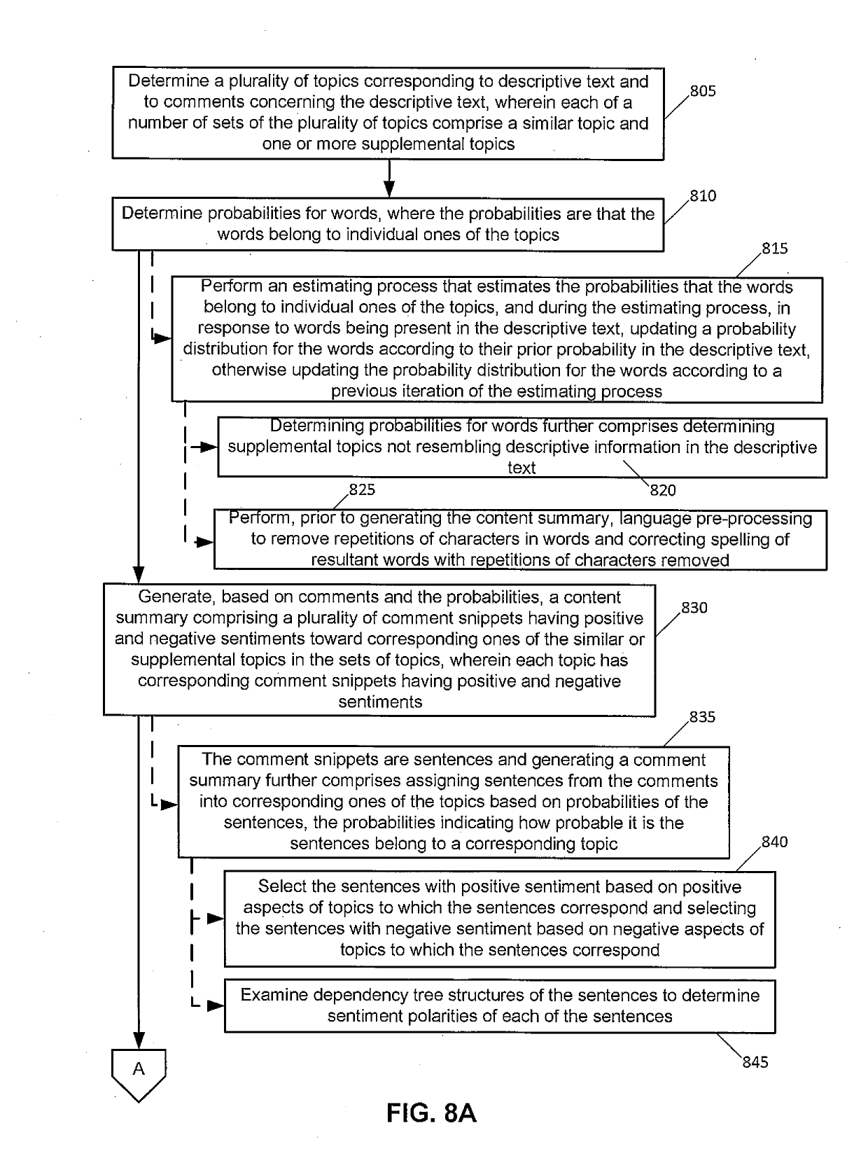

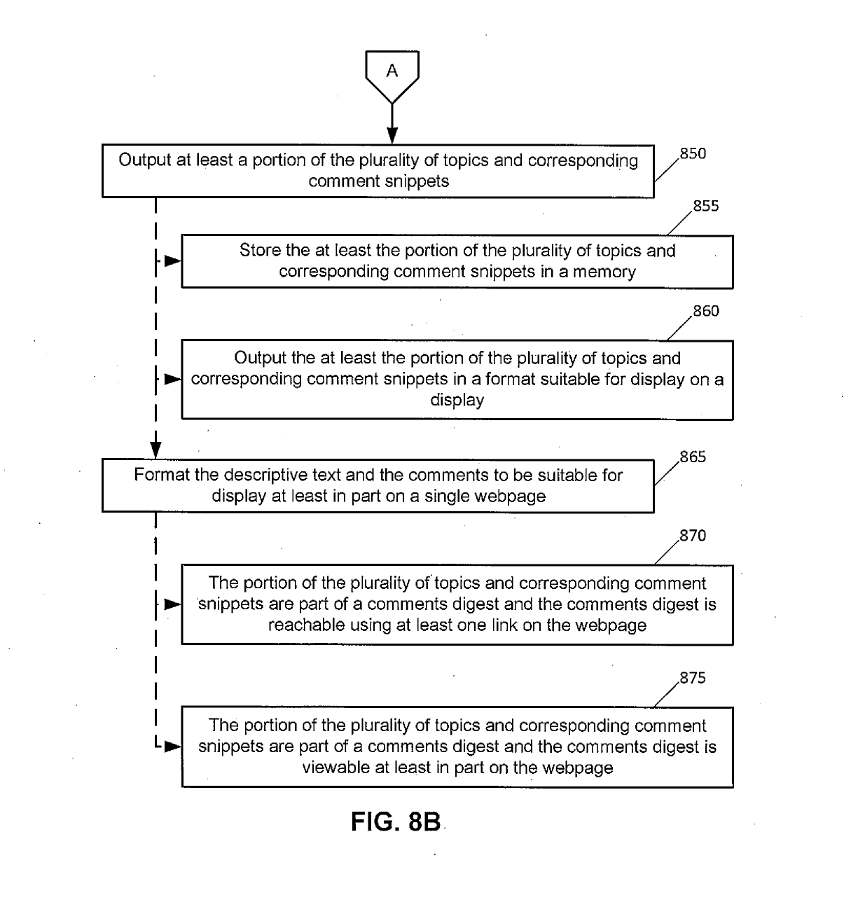

Turning to FIGS. 8A and 8B, collectively FIG. 8, these figures provide a logic flow diagram for topic modeling for comments analysis and use thereof. FIG. 8 also illustrates the operation of an exemplary method, a result of execution of computer program instructions embodied on a computer readable memory, functions performed by logic implemented in hardware, and/or interconnected means for performing functions in accordance with exemplary embodiments. Furthermore, the blocks in FIG. 8 may be considered to be interconnected means or modules for performing the function(s) in the blocks. The blocks in FIG. 8 may be performed by computer system 100, e.g., under control at least in part by the topic model analysis module 150.

In block 805, the computer system 100 determines a plurality of topics corresponding to descriptive text and to comments concerning the descriptive text. Each of a number of sets of the plurality of topics comprises a similar topic and one or more supplemental topics. In block 810, the computer system 100 determines probabilities for words, where the probabilities are that the words belong to individual ones of the topics. In block 830, the computing system 100 generates, based on comments and the probabilities, a content summary comprising a plurality of comment snippets having positive and negative sentiments. Each topic has corresponding comment snippets having positive and negative sentiments. In block 850, the computer system outputs at least a portion of the plurality of topics and corresponding comment snippets.

Block 815 is an example of block 810. Block 815 can be combined with any other block in the method of FIG. 8. In block 815, the computer system 100 performs an estimating process that estimates the probabilities that the words belong to individual ones of the topics, during the estimating process, in response to words being present in the descriptive text. The computing system also performs updating a probability distribution for the words according to their prior probability in the descriptive text, otherwise updating the probability distribution for the words according to a previous iteration of the estimating process. Blocks 820 and 825 are examples of block 815. In block 820, the computer system 100 determining probabilities for words further comprises determining supplemental topics not resembling descriptive information in the descriptive text. In block 825, the computer system 100 performs, prior to generating the content summary, language pre-processing to remove repetitions of characters in words and correcting spelling of resultant words with repetitions of characters removed.

Block 835 is an example of block 830. Block 835 can be combined with any other block in the method of FIG. 8. In block 835, the comment snippets are sentences and generating a comment summary further comprises assigning sentences from the comments into corresponding ones of the topics based on probabilities of the sentences, the probabilities indicating how probable it is the sentences belong to a corresponding topic. Blocks 840 and 845 are examples of block 835. In block 830, the computer system 100 selects the sentences with positive sentiment based on positive aspects of topics to which the sentences correspond and selecting the sentences with negative sentiment based on negative aspects of topics to which the sentences correspond. In block 845, the computer system 845 examines dependency tree structures of the sentences to determine sentiment polarities of each of the sentences.

Blocks 855 and 860 are examples of block 850. Blocks 855 and 860 can be combined with any other block in the method of FIG. 8. In block 855, the computer system 100 stores the at least the portion of the plurality of topics and corresponding comment snippets in a memory (or memories) 120. In block 860, the computer system 100 output the at least the portion of the plurality of topics and corresponding comment snippets in a format suitable for display on a display. In block 860, the computer system 100 formats the descriptive text and the comments to be suitable for display at least in part on a single webpage.

In block 865, the computer system 100 formats the descriptive text and the comments to be suitable for display at least in part on a single webpage. Block 865 can be combined with any other block in the method of FIG. 8. Blocks 870 and 875 are further examples of block 865. In block 870, the portion of the plurality of topics and corresponding comment snippets are part of a comments digest and the comments digest is reachable using at least one link on the webpage. In block 875, the portion of the plurality of topics and corresponding comment snippets are part of a comments digest and the comments digest is viewable at least in part on the webpage.

Another exemplary embodiment is an apparatus comprising means for performing any of the above blocks 805-875. A further exemplary embodiment is an apparatus comprising a one or more processors, and one or more memories including computer program code, where the one or more memories and the computer program code are configured, with the one or more processors, to cause the apparatus to perform any of the above blocks 805-875.

A further exemplary embodiment is a computer system comprising any one of the apparatus in the preceding paragraph and/or FIG. 1. A system comprising any one of the apparatus in the preceding paragraph and/or FIG. 1. The system of this paragraph, further comprising a user computer coupled to the apparatus, the user computer comprising a display that displays the at least a portion of the plurality of topics and corresponding comment snippets.

Another exemplary embodiment is a computer program, comprising code for performing any of the above blocks 805-875 when the computer program is run on a processor. The computer program according to this paragraph, wherein the computer program is a computer program product comprising a computer-readable medium bearing computer program code embodied therein for use with a computer.

While described above in reference to processors, these components may generally be seen to correspond to one or more processors, data processors, processing devices, processing components, processing blocks, circuits, circuit devices, circuit components, circuit blocks, integrated circuits and/or chips (e.g., chips comprising one or more circuits or integrated circuits).

Without in any way limiting the scope, interpretation, or application of the claims appearing below, a technical effect of one or more of the example embodiments disclosed herein is to provide summaries of comments for local descriptive text. Another technical effect of one or more of the example embodiments disclosed herein is to determine a comment summary using positive and negative sentiments. Another technical effect of one or more example embodiments is to provide a summary of comments, which should reduce the time a user will use to get an opinion of the subject of the descriptive text, such as to allow a user to reach an opinion of a product faster than simply browsing the comments.

Embodiments of the present invention may be implemented in software or hardware or a combination of software and hardware. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 1. A computer-readable medium may comprise a computer-readable storage medium that may be any media or means that can contain or store the instructions for use by or in connection with an instruction execution system, apparatus, or device, such as a computer, but the computer-readable storage medium does not encompass propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
determining a plurality of topics corresponding to descriptive text and to comments concerning the descriptive text, wherein each of a number of sets of the plurality of topics comprise a similar topic and one or more supplemental topics;
determining by a computer system probabilities for words, where the probabilities are that the words belong to individual ones of the topics;
generating, by the computer system and based on comments and the probabilities, a content summary comprising a plurality of comment snippets having positive and negative sentiments toward corresponding ones of the similar or supplemental topics in the sets of topics, wherein each topic has corresponding comment snippets having positive and negative sentiments; and
outputting by the computer system at least a portion of the plurality of topics and corresponding comment snippets.

2. The method of claim 1, wherein outputting further comprises formatting the descriptive text and the comments to be suitable for display at least in part on a single webpage.

3. The method of claim 2, wherein the portion of the plurality of topics and corresponding comment snippets are part of a comments digest and the comments digest is reachable using at least one link on the webpage.

4. The method of claim 2, wherein the portion of the plurality of topics and corresponding comment snippets are part of a comments digest and the comments digest is viewable at least in part on the webpage.

5. The method of claim 1, wherein determining probabilities for words further comprises performing an estimating process that estimates the probabilities that the words belong to individual ones of the topics, and during the estimating process, in response to words being present in the descriptive text, updating a probability distribution for the words according to their prior probability in the descriptive text, otherwise updating the probability distribution for the words according to a previous iteration of the estimating process.

6. The method of claim 5, wherein determining probabilities for words further comprises determining supplemental topics not resembling descriptive information in the descriptive text.

7. The method of claim 5, further comprising, prior to generating the content summary, performing language pre-processing to remove repetitions of characters in words and correcting spelling of resultant words with repetitions of characters removed.

8. The method of claim 1, wherein the comment snippets are sentences and generating a comment summary further comprises assigning sentences from the comments into corresponding ones of the topics based on probabilities of the sentences, the probabilities indicating how probable it is the sentences belong to a corresponding topic.

9. The method of claim 8, wherein generating the comment summary further comprises selecting the sentences with positive sentiment based on positive aspects of topics to which the sentences correspond and selecting the sentences with negative sentiment based on negative aspects of topics to which the sentences correspond.

10. The method of claim 8, wherein generating the comment summary further comprises examining dependency tree structures of the sentences to determine sentiment polarities of each of the sentences.

11. The method of claim 1, wherein outputting comprises storing the at least the portion of the plurality of topics and corresponding comment snippets in a memory of the computer.

12. The method of claim 1, wherein outputting comprises outputting the at least the portion of the plurality of topics and corresponding comment snippets in a format suitable for display on a display.

13. A computer program product comprising a computer-readable storage medium bearing computer program code embodied therein for use with a computer, the computer program code comprising:
code for determining a plurality of topics corresponding to descriptive text and to comments concerning the descriptive text, wherein each of a number of sets of the plurality of topics comprise a similar topic and one or more supplemental topics;
code for determining by a computer system probabilities for words, where the probabilities are that the words belong to individual ones of the topics;
code for generating, by the computer system and based on comments and the probabilities, a content summary comprising a plurality of comment snippets having positive and negative sentiments toward corresponding ones of the similar or supplemental topics in the sets of topics, wherein each topic has corresponding comment snippets having positive and negative sentiments; and
code for outputting by the computer system at least a portion of the plurality of topics and corresponding comment snippets.

14. An apparatus, comprising:
one or more processors; and
one or more memories including computer program code,
the one or more memories and the computer program code configured, with the one or more processors, to cause the apparatus to perform at least the following:
determining a plurality of topics corresponding to descriptive text and to comments concerning the descriptive text, wherein each of a number of sets of the plurality of topics comprise a similar topic and one or more supplemental topics;
determining probabilities for words, where the probabilities are that the words belong to individual ones of the topics;
generating, based on comments and the probabilities, a content summary comprising a plurality of comment snippets having positive and negative sentiments toward corresponding ones of the similar or supplemental topics in the sets of topics, wherein each topic has corresponding comment snippets having positive and negative sentiments; and
outputting at least a portion of the plurality of topics and corresponding comment snippets.

15. The apparatus of claim 14, wherein outputting further comprises formatting the descriptive text and the comments to be suitable for display at least in part on a single webpage.

16. The apparatus of claim 15, wherein the portion of the plurality of topics and corresponding comment snippets are part of a comments digest and the comments digest is reachable using at least one link on the webpage.

17. (canceled)

18. The apparatus of claim 14, wherein determining probabilities for words further comprises performing an estimating process that estimates the probabilities that the words belong to individual ones of the topics, and during the estimating process, in response to words being present in the descriptive text, updating a probability distribution for the words according to their prior probability in the descriptive text, otherwise updating the probability distribution for the words according to a previous iteration of the estimating process.

19. (canceled)

20. (canceled)

21. The apparatus of claim 14, wherein the comment snippets are sentences and generating a comment summary further comprises assigning sentences from the comments into corresponding ones of the topics based on probabilities of the sentences, the probabilities indicating how probable it is the sentences belong to a corresponding topic.

22. (canceled)

23. (canceled)

24. The apparatus of claim 14, wherein outputting comprises storing the at least the portion of the plurality of topics and corresponding comment snippets in the one or more memories of the apparatus.

25. The apparatus of claim 14, wherein outputting comprises outputting the at least the portion of the plurality of topics and corresponding comment snippets in a format suitable for display on a display.
